(19) United States
(12) Patent Application Publication
(10) Pub. No.: US 2004/0171289 A1
(43) Pub. Date: Sep. 2, 2004

(54) Electrical connector of electrical cooking device

(76) Inventor: Wu Chang Li-Chen, Pa-Te City (TW)

Correspondence Address: SUPREME PATENT SERVICES, POST OFFICE BOX 2339, SARATOGA, CA, 95070, US

(21) Appl. No.: 10/378,234

(22) Filed: Mar. 1, 2003

(51) Int. Cl. H01R 13/44

(52) U.S. Cl. 439/137

(57) ABSTRACT

An electrical connector is mounted in an outer container of an electrical cooking device for electrical connection with an inner container. The connector includes a casing in which two receiving slots are defined. Two resilient conductive plates are arranged inside the casing and are selectively connected with an external power source. A slide lid is movably arranged inside the casing and is biased by a spring toward a closed position where the slide lid closes the receiving slots. Two driving blocks are formed on the slide lid and corresponding in position to the receiving slots. Each driving block has an inclined surface. The inner container includes an electrical heating element forming two terminal pins, which get into the slots when the inner container is deposited into the outer container. The movement of terminal pins into the slots causes the terminal pins to engage the inclined surfaces of the driving blocks and moving the slide lid from the closed position to an open position thereby exposing the slots to allow the terminal pins to get into the casing and physically engage the resilient conductive plates.

### FIELD OF THE INVENTION

The present invention relates generally to an electrical cooking device comprising an inner container removably positioned in an outer container, and in particular to an electrical connector between the inner container and the outer container having a simple structure and low costs.

### BACKGROUND OF THE INVENTION

Cooking is daily activity for families. One of the most commonly used cooking devices is the electrical cooking device which is powered by electricity that is a handy energy source nowadays. Electrical cooking devices are available in the market and are well known, such as Taiwan Utility Model Publication No. 501464 which discloses an electrical cooking device comprising an outer container defining an interior space for receiving and removably retaining an inner container. Electrical heaters are mounted to a bottom of the inner container and two terminals of the electrical heaters are engageable with an electrical connector mounted inside the outer container to form an electrical path therebetween.

To avoid potential dangers of electrical shorting and electrical shock to a user, the electrical connector of the conventional electrical cooking device comprises a slidable cover movable between a shielding position and an open position. When the inner container is not positioned into the outer container, the slidable cover is, spring-biased to the shielding position to completely cover the conductors inside the connector whereby electrical shorting and electrical shock can be effectively prevented. A drive tab is mounted to the bottom of the inner container which, when the inner container is positioned into the outer container, engages and drives the slidable cover to the open position to allow the terminals of the electrical heaters to get into the connector and physically engaging the conductors of the connector.

Such a conventional design, although effective in preventing electrical shorting and electrical shock, is complicated in structure which in turn increases costs of manufacturing and maintenance. Operation reliability is another problem for such a complicated structure.

It is thus desired to have an electrical connector for an electrical cooking device to overcome the above problems.

### SUMMARY OF THE INVENTION

An object of the present invention is to provide an electrical connector for electrically coupling an inner container of an electrical cooking device to an outer container of the cooking device, the connector having a simple structure and thus low costs.

Another object of the present invention is to provide an electrical connector for selectively and reliably forming electrical engagement between inner and outer containers of an electrical cooking device.

To achieve the above object, in accordance with the present invention, there is provided an electrical connector mounted in an outer container of an electrical cooking device for electrical connection with an inner container. The connector comprises a casing in which two receiving slots are defined. Two resilient conductive plates are arranged inside the casing and are selectively connected with an external power source. A slide lid is movably arranged inside the casing and is biased by a spring toward a closed position where the slide lid closes the receiving slots. Two driving blocks are formed on the slide lid and corresponding in position to the receiving slots. Each driving block has an inclined surface. The inner container includes an electrical heating element forming two terminal pins which get into the slots when the inner container is deposited into the outer container. The movement of terminal pins into the slots causes the terminal pins to engage the inclined surfaces of the driving blocks and moving the slide lid from the closed position to an open position thereby exposing the slots to allow the terminal pins to get into the casing and physically engage the resilient conductive plates.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of an electrical cooking device in which an electrical connector constructed in accordance with the present invention is embodied;

FIG. 2 is an up-side-down perspective view of a bottom portion of an inner container of the electrical cooking device;

FIG. 3 is a perspective view of the electrical connector of the present invention;

FIG. 4 is a cross-sectional view of the electrical connector of the present invention;

FIG. 5 is another cross-sectional view of the electrical connector of the present invention;

FIG. 6 is a cross-sectional view similar to FIG. 4 but showing an open and thus operating position of the electrical connector;

FIG. 7 is a cross-sectional view similar to FIG. 5 but showing the open position of the electrical connector.

### DETAILED DESCRIPTION OF THE INVENTION

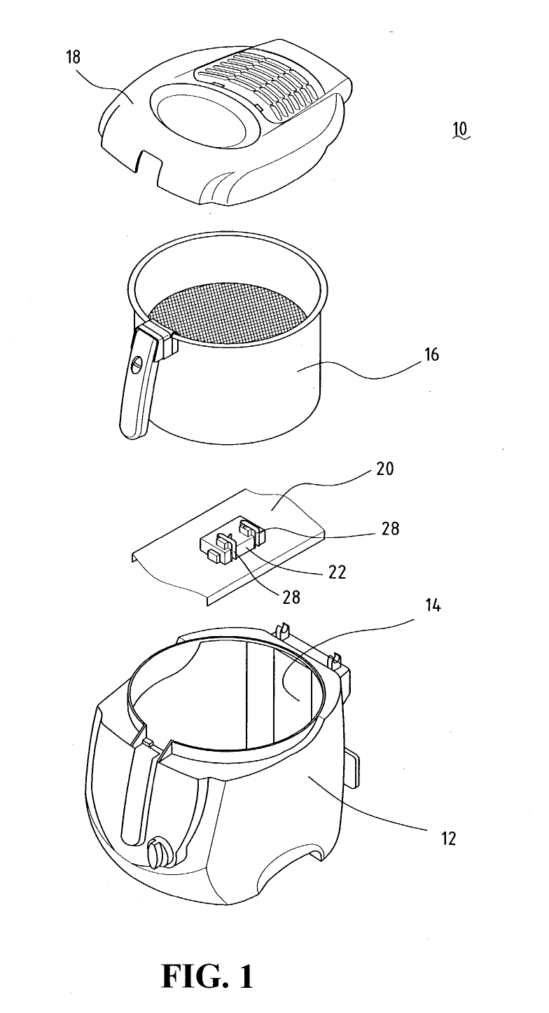

With reference to the drawings and in particular to FIG. 1, an electrical cooking device, generally designated with reference numeral 10, comprises an outer container 12 defining an interior space 14 in which an inner container 16 is removably received. A cover 18 is movably or openably attached to the outer container 12 for selectively covering the inner container 16 received in the outer container 12. The outer container 12 has a bottom wall 20 on which an electrical connector 22 constructed in accordance with the present invention is mounted. The electrical connector 22 can be electrically connected to an external power source, such as wall outlet of an electric main, by any known means (not shown). This is well known and thus no further detail is needed herein.

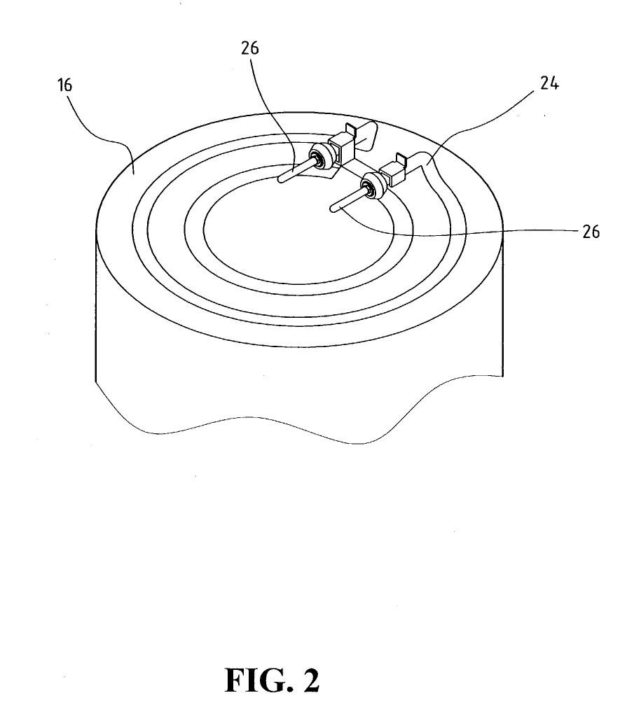

Also referring to FIG. 2, the inner container 16 comprises a bottom (not labeled) to which an electrical heating element 24 or the like is mounted for providing heat to cook food stuffs (not shown) contained in the inner container 16. The heating element 24 comprises two conductive terminal pins 26 exposed outside the bottom of the inner container 16. Corresponding to the terminal pins 26 of the heating element 24, the electrical connector 22 defines two receiving slots 28 into which the terminal pins 26 are received in a substantially vertical direction to form electrical connection with the electrical connector 22.

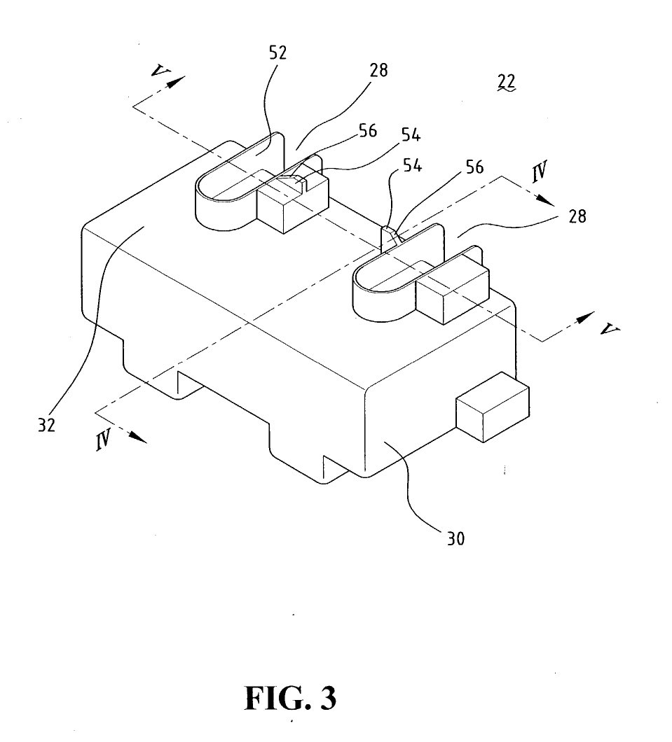

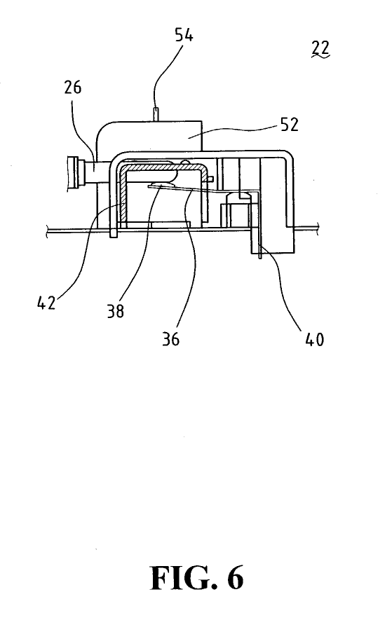

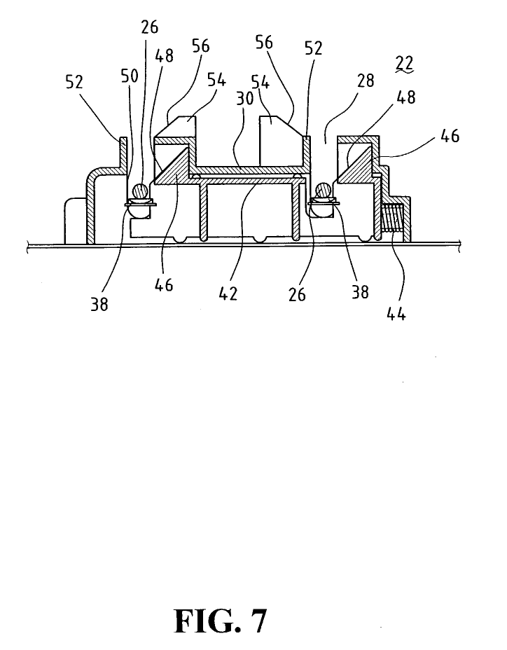

Also referring to FIGS. 3-5, the electrical connector 22 comprises an insulation casing 30 mounted to the bottom wall 20 of the outer container 12. The casing 30 has a top face 32 in which the receiving slots 28 are defined. The casing 30 defines an interior space in communication with the slots 28. Two resilient plates 36 made of conductive materials, such as metal, are mounted inside the casing 30. In the embodiment illustrated, the resilient plates 36 are mounted as cantilever beams, each having a free end on which a conductive pad 38 is formed and a fixed end 40 partially extending beyond the casing 30 for selectively connecting the external power source. The resilient plates 36 are positioned so that the conductive pads 38 are corresponding in position to the receiving slots 28 whereby when the terminal pins 26 of the heating element 24 are received into the slots 28, the terminal pins 26 physically engage the conductive pads 38, as shown in FIGS. 6 and 7, forming an electrical connection therebetween.

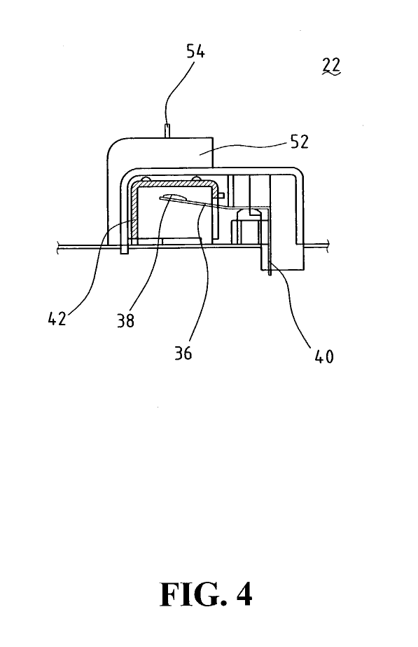

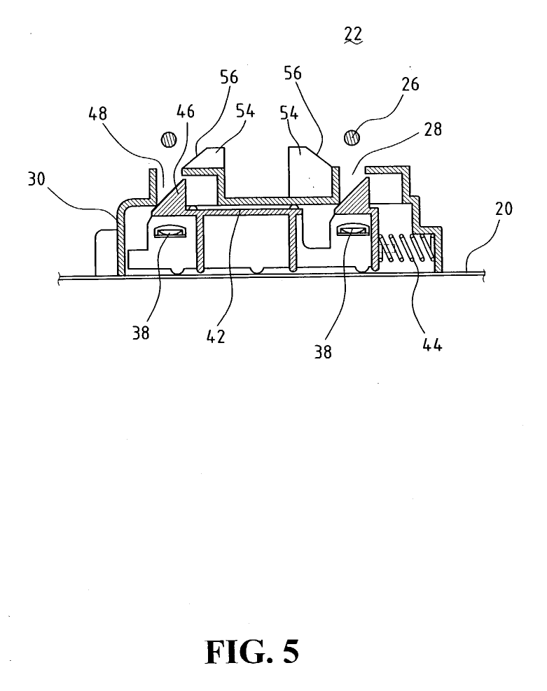

The casing 30 further comprises a slide lid 42 which is movably arranged in the interior space of the casing 30 and is biased by a resilient element, such as a helical spring 44 positioned between the slide lid 42 and the casing 30, toward a closed position as shown in FIGS. 4 and 5 where the receiving slots 28 are closed by the slide lid 42. The slide lid 42 is also movable away from the closed position to an open position as shown in FIGS. 6 and 7 by applying an external force in a horizontal direction to overcome the biasing spring 44. This exposes the receiving slots 28 for receiving the terminal pins 26 of the heating element 24.

When the slide lid 42 is at the closed position, portions of the slide lid 42 are exactly located between the receiving slots 28 and the conductive pads 38 thereby closing the slots 28 and effectively shielding the conductive pads 38, avoiding any potential dangers of electrical shorting and electrical shock to a user by accidentally touching the conductive pads 38.

The slide lid 42 comprises a driving block 46 formed thereon at a position corresponding to each receiving slot 28 whereby when the slide lid 42 is at the closed position, the driving block 46 is exactly located below the corresponding receiving slot 28 as shown in FIG. 5. The driving block 46 has an inclined camming surface 48 that engages the terminal pin 26 of the heating element 24 received into the slot 28. The camming surface 48 converts a vertically downward force induced by depositing the inner container 16 into the outer container 12 into a transverse horizontal driving force that moves the slide lid 42 from the closed position toward the open position to expose the slot 28 thereby allowing the terminal pin 26 to be smoothly moved into the casing 30 for engaging the conductive pad 38.

The resiliency of the resilient plate 36 that supports the conductive pad 38 provides a reaction force when the terminal pin 26 of the heating element 24 engages the conductive pad 38, which ensures firm and reliable engagement between the terminal pin 26 and the conductive pad 38.

To ensure smooth movement of the terminal pins 26 of the heating element 24 into and/or out of the receiving slots 28 and to ensure that the movement of the terminal pins 26 into/out of the receiving slots 28 is not adversely affected by the biasing force of the spring 44, the casing 30 forms an inner guide structure 50 which is preferably integrally formed with the casing 30. The guide structure 50 limits transverse movement of the terminal pins 26 and only allows movement of the terminal pins 26 in the vertical direction. In this way, the terminal pins 26 are smoothly guided into and out of the receiving slots 28.

In the embodiment illustrated, the slots 28 are defined by side walls 52 extending beyond the top face 32 of the casing 30. Preferably, the side walls 52 or at least one of which forms a continuous surface for guiding the movement of the terminal pins 26 into and/or out of the slots 28.

In case the inner container 16 is not properly positioned into the outer container 12, to ensure the terminal pins 26 of the heating element 24 can be properly moved into the slots 28 of the connector 22, a guiding member 54 having an inclined surface 56 directing into the slot 28 is formed on at least one side of the slot 28. In the embodiment illustrated, each slot 28 is associated with one guiding member 54 and the inclined surfaces 56 are directed into the slots 28 in a diverging manner. If desired, the inclined surfaces 56 can be formed in a converging manner, namely extending toward each other in a direction toward the slots 28. In addition, each slot 28 can be associated with two such guiding members 54 on opposite sides thereof with the inclined surfaces 56 facing each other.

To this point, it is understood that the electrical connector in accordance with the present invention has a simple structure, ensuring operation reliability, and low manufacturing costs.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An electrical connector adapted to be mounted in an outer container of a cooking device for electrically engaging terminal pins of an inner container of the cooking device, the connector comprising:
an insulation casing forming an interior space and defining at least one receiving slot in communication with the interior space for receiving the terminal pin of the inner container into the interior space of the casing;
at least one conductive plate arranged in the interior space of the casing, the plate comprising a conductive pad corresponding in position to the slot whereby when the terminal pin is received through the receiving slot, the terminal pin physically engages the conductive pad to form electrical connection therebetween;
a slide lid arranged inside the casing and movable between a closed position where a portion of the slide lid covers the slot and shields the conductive pad and an open position where the slot is exposed to allow the terminal pin to move into the casing to engage the conductive pad; and
a biasing element arranged between the slide lid and the casing for biasing the slide lid toward the closed position.

2. The electrical connector as claimed in claim 1, wherein the slide lid comprises a driving block mounted thereto at a position corresponding to and thus covering the slot when the slide lid is at the closed position, the driving block having an inclined camming surface which, when engaging the terminal pin, facilitates moving the slide lid from the closed position to the open position.

3. The electrical connector as claimed in claim 1, wherein he biasing element comprises a spring.

4. The electrical connector as claimed in claim 3, wherein the spring is a helical spring.

5. The electrical connector as claimed in claim 1, wherein the casing comprises an inner guide structure for guiding movement of the terminal pin into/out of the slot.

6. The electrical connector as claimed in claim 5, wherein the slot is defined by side walls extending beyond the casing, at least one of the side walls forming a continuous guiding surface with the inner guide structure for guiding the movement of the terminal pin.

7. The electrical connector as claimed in claim 1, wherein the plate is mounted in a cantilevered manner having a free end to which the conductive pad is mounted.

8. The electrical connector as claimed in claim 1, wherein the casing defines two receiving slots and wherein two plates each supporting a conductive pad are arranged in the interior space respectively corresponding to the receiving slots, the slide lid covering both slots at the closed position.

9. The electrical connector as claimed in claim 2, wherein the casing defines two receiving slots and wherein two plates each supporting a conductive pad are arranged in the interior space respectively corresponding to the receiving slots, the slide lid comprising two driving blocks each having an inclined camming surface, the driving blocks respectively closing the slots at the closed position, the slots respectively allowing two terminal pins of the inner container to move therethrough, the movement of the terminal pins causing engagement of the terminal pins with the inclined surfaces and driving the slide lid toward the open position whereby the terminal pins are allowed to engage the corresponding conductive pads of the casing.

10. The electrical connector as claimed in claim 9, wherein the plates are mounted in a cantilevered manner, each having a free end to which the conductive pad is mounted.

11. The electrical connector as claimed in claim 1, further comprising a guiding member formed on the casing associated with the slot, the guiding member having an inclined surface directing toward the slot for helping guiding the terminal pin into the slot.
